(19) United States
(12) Patent Application Publication
(10) Pub. No.: US 2023/0382257 A1
(43) Pub. Date: Nov. 30, 2023

(54) MONITORING AND MANAGEMENT METHODS AND SYSTEMS FOR ROAMING CHARGING STATION OPERATOR

(71) Applicant: Noodoe Group Inc., Wilmington, DE (US)

(72) Inventors: Yi-An HOU, Taipei City (TW); Chun-Hung KUNG, Taipei City (TW)

(21) Appl. No.: 18/303,793

(22) Filed: Apr. 20, 2023

(30) Foreign Application Priority Data
May 27, 2022 (TW) 111119925

(51) Int. Cl. B60L 53/62; B60L 53/67; B60L 53/30

(52) U.S. Cl. CPC B60L 53/62; B60L 53/305; B60L 53/67

(57) ABSTRACT

Monitoring and management methods and systems for roaming charging station operator for use in a server are provided. First, state data of at least one electric vehicle charging station corresponding to a charging station operator is received via a network. A service quality index of the charging station operator or the electric vehicle charging station is calculated according to the state data corresponding to the at least one electric vehicle charging station. Then, a user interface is provided to display the service quality index.

### BACKGROUND OF THE INVENTION

### Field of the Invention

The disclosure relates generally to charging management methods and systems for electric vehicle charging stations, and, more particularly to methods and systems that can monitor and manage roaming charging station operators based on the status of electric vehicle charging stations.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

Currently, different electric vehicle charging stations can be set up and managed by different charging station operators. To provide a more user-friendly electric vehicle charging experience, many operators of electric vehicle charging stations have developed applications on mobile phones that allow users to search for electric vehicle charging stations, start charging, stop charging, and view charging progress and other functions. Individual charging station operators can invite users to become members and offer a variety of charging options to meet the needs of different users. As electric vehicle users may carry out long-distance or cross-regional movement, such as traveling, and there may only be electric vehicle charging stations of a particular charging station operator available in a particular area. As a result, it is often the case that members of one charging station operator goes to another charging station operator's electric vehicle charging station to charge their vehicles. In view of this, the industry refers to this behavior as “roaming charging”. In the case of “roaming charging”, an E-mobility service provider (EMSP) can offer roaming contracts of charging for the users to provide electric vehicle charging services.

In the “roaming charging” environment, a charging roaming management platform can exist between the E-mobility service provider and the charging station operator. In other words, the contract signing, data exchange, and so on between the E E-mobility service providers and charging station operators can all be carried out through the charging roaming management platform. In some cases, the charging roaming management platform is required to ensure the quality of service at the electric vehicle charging station owned by the charging station operator, and provide relevant information to the E-mobility service provider and its users to facilitate subsequent charging station inquiries and related applications, so as to avoid complaints from users due to unstable quality of service.

### BRIEF SUMMARY OF THE INVENTION

In an embodiment of a monitoring and management method for roaming charging station operator for use in a server, state data of at least one electric vehicle charging station corresponding to a charging station operator is first received via a network. A service quality index of the charging station operator or the at least one electric vehicle charging station is calculated according to the state data corresponding to the at least one electric vehicle charging station. Then, a user interface is provided to display the service quality index of the charging station operator or the at least one electric vehicle charging station.

An embodiment of a monitoring and management system for a roaming charging station operator comprises at least one electric vehicle charging station and a server. The at least one electric vehicle charging station corresponds to a charging station operator for performing at least one charging operation on at least one electric vehicle. The server receives state data of at least one electric vehicle charging station corresponding to the charging station operator via a network, calculates a service quality index of the charging station operator or the at least one electric vehicle charging station according to the state data corresponding to the at least one electric vehicle charging station, and provides a user interface to display the service quality index of the charging station operator or the at least one electric vehicle charging station.

In some embodiments, it is determined whether the service quality index is lower than a predetermined value. When the service quality index is lower than the predetermined value, the roaming charging operation at the at least one electric vehicle charging station corresponding to the charging station operator is suspended.

In some embodiments, a removal instruction is transmitted to at least one E-mobility service provider via the network. In response to the removal instruction, the at least one electric vehicle charging station corresponding to the charging station operator is removed from a roaming charging list by the at least one E-mobility service provider, wherein the roaming charging list records a plurality of candidate electric vehicle charging stations where at least one member of the at least one E-mobility service provider can perform roaming charging.

In some embodiments, a suspend function corresponding to the charging station operator is provided through an interface. A suspend command is received from at least one E-mobility service provider through the network to enable the suspend function to suspend roaming charging at the at least one electric vehicle charging station corresponding to the charging station operator.

In some embodiments, the state data includes a usage status, an offline status, or a failure status corresponding to the at least one electric vehicle charging station.

In some embodiments, it is determined whether there is a charging dispute between the charging station operator and at least one E-mobility service provider and the charging dispute can't be resolved within a predetermined period. When there is a charging dispute between the charging station operator and the at least one E-mobility service provider and the charging dispute can't be resolved within the predetermined period, the roaming charging operation at the at least one electric vehicle charging station of the charging station operator is suspended. In some embodiments, the roaming charging operation at the at least one electric vehicle charging station of the charging station operator is re-enabled when the charging dispute is resolved.

In some embodiments, an application corresponding to the charging dispute is received from the at least one E-mobility service provider through an interface. The charging station operator is then notified to handle the charging dispute within the predetermined period through the interface.

In some embodiments, the server belongs to a charging roaming management platform, and it is determined whether the charging station operator fulfills a payment contract between the charging station operator and the charging roaming management platform. When the payment contract is not fulfilled, the roaming charging operation at the at least one electric charging station of the charging station operator is suspended.

Monitoring and management methods for roaming charging station operator may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a monitoring and management system for roaming charging station operator of the invention;

FIG. 2 is a schematic diagram illustrating an embodiment of an electric vehicle charging station of the invention;

FIG. 3 is a schematic diagram illustrating an embodiment of a server of the invention;

FIG. 4 is a flowchart of an embodiment of a monitoring and management method for roaming charging station operator of the invention;

FIG. 5 is a flowchart of another embodiment of a monitoring and management method for roaming charging station operator of the invention;

FIG. 6 is a flowchart of another embodiment of a monitoring and management method for roaming charging station operator of the invention;

FIG. 7 is a flowchart of another embodiment of a monitoring and management method for roaming charging station operator of the invention; and

FIG. 8 is a flowchart of another embodiment of a monitoring and management method for roaming charging station operator of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

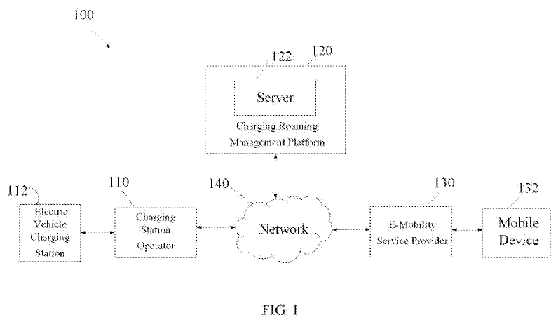

FIG. 1 is a schematic diagram illustrating an embodiment of a monitoring and management system for roaming charging station operator of the invention. The monitoring and management system for roaming charging station operator 100 comprises a charging station operator (also referred to as a charge point operator (CPO)) 110, a charging roaming management platform 120 and an E-mobility service provider (also referred to as an eMSP or EMSP) 130. Note that the charging station operator 110 and the E-mobility service provider 130 can be coupled to the charging roaming management platform 120 through a network 140. In some embodiments, the network 140 may be a wired network, a telecommunication network, and a wireless network, such as a Wi-Fi network. The charging station operator 110 can perform related charging management operations for at least one electric vehicle charging station 112 through the network, and the electric vehicle charging station 112 can provide electric vehicles for a charging operation. It is noted that the at least one electric vehicle charging station 112 may be located in one or different charging areas. The charging roaming management platform 120 may include a server 122 for communicating with the charging station operator 110 to receive information about the electric vehicle charging station 112, information about the corresponding charging operations and other information from the charging station operator 110 via the network 140. The E-mobility service provider 130 can provide its members with the ability to use a mobile device 232 to perform roaming charging of electric vehicles across charging station operators. In some embodiments, the E-mobility service provider 130 and the charging station operator 110 may sign a contract to carry out a charging agreement, etc., and perform roaming charging of electric vehicles through the charging roaming management platform 120. When members of the E-mobility service provider 130 use the mobile device 132 to charge their electric vehicles at the electric vehicle charging station 112 of the charging station operator 210, the certification operation for the respective charging operation will be performed by the E-mobility service provider 130, and then notifies the charging station operator 110 to control the electric vehicle charging station 112 to perform the charging operation through the charging roaming management platform 120. The server 122 of the charging roaming management platform 120 can communicate with the charging station operator 110 through the network 140 to receive relevant information about the charging operation performed by the corresponding electric vehicle charging station 112 from the charging station operator 110. It should be noted that, the charging roaming management platform 120, the charging station operator 210, and the E-mobility service provider 130 can implement relevant roaming protocols/agreements to obtain relevant charging station information and related information for the corresponding charging operation.

It is noted that the charging station operator can have a management server to receive various data from respective electric vehicle charging stations through the network, and transmit related signals to the electric vehicle charging stations through the network. The electric vehicle charging stations can perform related operations according to the signals received from the manager server. For example, when an electric vehicle is coupled to the electric vehicle charging station through a charging gun of the electric vehicle charging station for a charging operation, the electric vehicle charging station can continuously transmit charging information corresponding the charging operation of respective electric vehicle via the network, and the manager server can receive the charging information of the corresponding charging operation from the electric vehicle charging station via the network.

It is noted that the user can connect the electric vehicle and the electric vehicle charging station to each other, such as inserting a charging gun into the charging port of the electric vehicle to send a charging request corresponding to the electric vehicle charging station to use the electric vehicle charging station to perform a charging operation for the electric vehicle. It is understood that, in some embodiments, the manager server of the charging station operator may directly or indirectly receive a charging request from a mobile device of the owner of the electric vehicle, and generate a charging authorization command based on the charging request and transmit it to the electric vehicle charging station via the network, so that the electric vehicle charging station outputs power to the electric vehicle, such as an electric scooter or an electric car, which is electrically connected to it, or prohibits the electric vehicle charging station from outputting power to the electric vehicle. It is reminded that, in some embodiments, the charging request may be accompanied by an identity authentication and/or a payment mechanism, and the charging authorization command will only be generated after the identity authentication and/or payment mechanism is completed. As aforementioned, in some embodiments, the identity authentication and/or payment mechanism may be performed by the E-mobility service provider. In some embodiments, the user of the electric vehicle can use his/her mobile device to download and install an application to generate a charging request through the user interface of the application. In some embodiments, the user can scan a Quick Response Code (QR code) on the electric vehicle charging station through the scanning function of the application to generate the above-mentioned charging request, thereby starting a charging operation. In some embodiments, the user can select a specific charging station through the application and execute an activation function to generate the above-mentioned charging request, thereby starting a charging operation. It is understood that, in some embodiments, the owner of the electric vehicle can use an RFID card to approach an induction area (not shown in FIG. 1) on the electric vehicle charging station to generate a corresponding charging request, and send it to the manager server via the network. It is reminded that, in some embodiments, each user (the owner of the electric vehicle) can have an RFID card. It is noted that, in some embodiments, the owner of the electric vehicle may be a member of the E-mobility service provider and wish to query the charging station operators and their electric vehicle charging stations for roaming charging through the interface provided by the E-mobility service provider.

It is noted that, the mobile device 132 of the owner of the electric vehicle can be any electronic device capable of Internet access, such as mobile devices, such as mobile phones, smart phones, personal digital assistants, global positioning systems, and notebook computers. In some embodiments, the mobile device 132 can receive status information and notifications of the corresponding charging operation from the E-mobility service provider 130 via the network. In some embodiments, the status information and notification may include notifying that the electric vehicle has stopped charging, notifying that the vehicle needed to be moved, and/or notifying that the charging gun of the electric vehicle charging device has been disconnected from the electric vehicle, and so on.

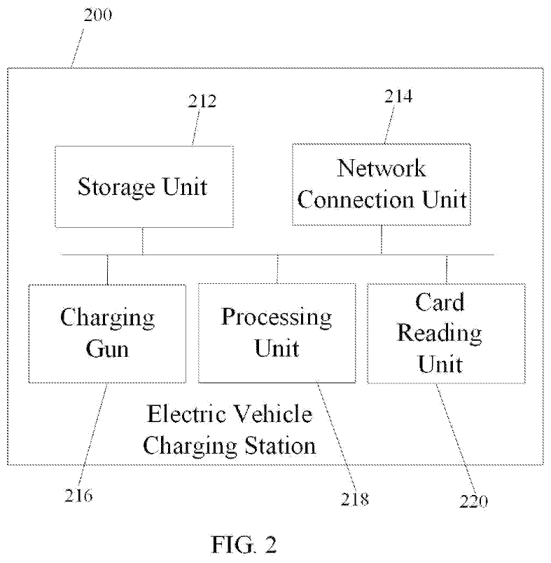

FIG. 2 is a schematic diagram illustrating an embodiment of an electric vehicle charging station of the invention. The electric vehicle charging station 200 shown in FIG. 2 can be applied to the electric vehicle charging stations 112 in FIG. 1, which has processing and computing capabilities to perform charging management operations for the electric vehicle charging station. The electric vehicle charging station 200 has a network connection capability to receive, download or update various parameters and information required for charging management calculations.

The electric vehicle charging station 200 at least comprises a storage unit 212, a network connection unit 214, a charging gun 216, a processing unit 218, and a card reading unit 220. The storage unit 212 may be a memory or a database for storing and recording related data. The data may be related information such as charging station ID of the electric vehicle charging station and charging requests. It should be noted that the aforementioned information is only example, and the invention is not limited thereto. The network connection unit 214 can use a network, such as a wired network, a telecommunications network, and a wireless network, such as a Wi-Fi network, to receive, download, or update various parameters and information required for charging management operations. The charging gun 216 may include one or more charging connectors that meet the same charging interface specification or meet different charging interface specifications, and are electrically connected to the corresponding electric vehicle. The processing unit 218 can control the operations of related software and hardware in the electric vehicle charging station 200. It is noted that, in some embodiments, the processing unit 218 may be a general-purpose controller, a Micro-Control Unit, MCU, or a Digital Signal Processor, DSP, etc., to provide functions of data analysis, processing and calculation, but the present invention is not limited thereto. In one embodiment, the processing unit 218 may use the network connection unit 214 to transmit the power state of the corresponding electric vehicle through a network for a cloud management server for subsequent charging management. In another embodiment, the processing unit 218 can obtain the power parameter of a charging operation from the manager server, determine the output power according to the power parameter received from the manager server, and output the power to at least one electric vehicle through the charging gun 216 to perform the charging operation. The card reading unit 220 may be an RFID reading unit for sensing information of a physical card, such as RFID card. The information sensed from the RFID card may be a card identification code of the physical card.

It is understood that, the electric vehicle charging station 200 has an upper power limit value and a lower power limit value. Specifically, the electric vehicle charging station 200 can use the upper power limit value as the power parameter at the highest to output power to the electric vehicle during a charging operation. On the other hand, the electric vehicle charging station 200 needs to use the lower power limit value as the power parameter at least to output power to the electric vehicle during a charging operation. It must be noted that, charging stations of different brands and models may have different upper power limit values for output power and lower power limit values for output power. The present invention is not limited to any value, and the value may be different for different charging stations.

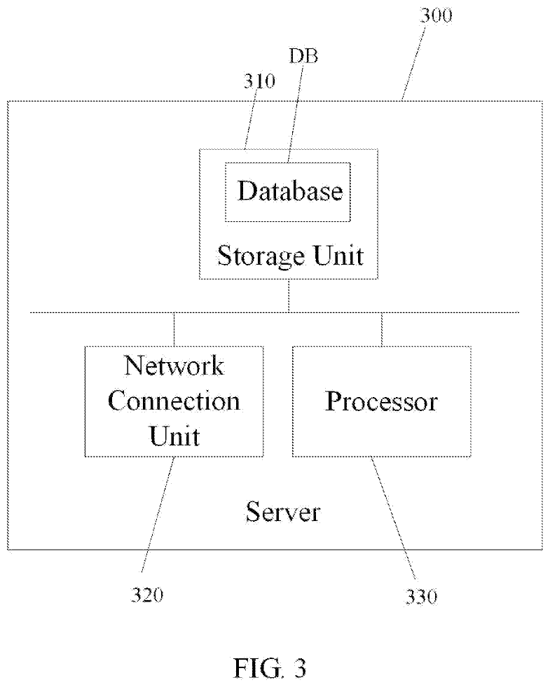

FIG. 3 is a schematic diagram illustrating an embodiment of a server of the invention. It is noted that the server 300 in FIG. 3 can be applied to the servers 122 in FIG. 1. As shown in FIG. 3, the server 300 of the invention can be any processor-based electronic device, which comprises at least a storage unit 310, a network connection unit 320, and a processor 330. It is noted that, the server 300 can receive various data corresponding to a plurality of electric vehicle charging stations in individual charging fields from the charging station operators. The server 300 can directly or indirectly receive a charging request from a mobile device, and after completing actions such as identity confirmation in response to the charging request, generate a charging authorization command and transmit it to the corresponding electric vehicle charging station via the network. In response to the charging authorization command, the electric vehicle charging station is allowed to output power to an electric vehicle (for example, an electric motorcycle or an electric vehicle, etc.) that is electrically connected to it, or prohibit the electric vehicle charging station from outputting power to the electric vehicle.

The storage unit 310 may be a memory comprising a database DB, which can store and record related data, such as various data of the charging station operators/the electric vehicle charging stations. It is noted that when the server is located on the charging roaming management platform, the database DB also records the related information corresponding to the E-mobility service provider. In addition, in some embodiments, the database DB can also record corresponding different charging station operators, E-mobility service providers, users, and their respective identification codes. In some embodiments, the database DB may record the formats and fields of charging station data corresponding to different charging station operators. Through the network connection unit 320, the server 300 can be coupled to and communicates with the charging station operators/electric vehicle charging stations/electric mobile service providers via the network, such as a wired network, a telecommunications network, and a wireless network, such as a Wi-Fi network, and transmits related data/signals/commands to different charging station operators/electric vehicle charging stations/electric mobile service providers via the network to control whether the electric vehicle charging stations output power, and specify power parameters for outputting power to electric vehicles, and further perform relevant data transmission and exchange. On the other hand, through the network connection unit 320, the server 300 can also be coupled and communicates with the mobile device via the network, and transmit related data/signals/commands to the mobile device via the network. The processor 330 can control the operations of related software and hardware in the server 300, and execute the monitoring and management method for roaming charging station operator of the invention. The relevant details will be described later. It is understood that, in some embodiments, the processor 330 may be a general-purpose controller, a Micro-Control Unit, MCU, or a Digital Signal Processor, DSP, etc., to provide data analysis, processing, and calculation functions.

It should be understood that each of the elements, units or modules in the present embodiments may be a device having a corresponding function, which can have the appropriate hardware circuits or elements to perform the corresponding function, however, the device is not limited to be entity device, which can also be a virtual device having program and software with respective functions or a device having capabilities for processing and running the program and software. The manner of operations of the respective elements can further refer to the following description of the methods.

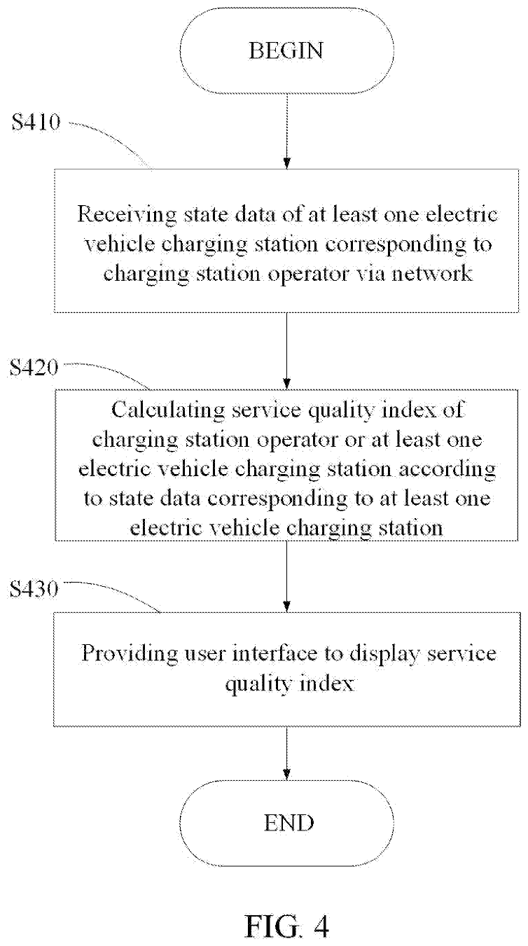

FIG. 4 is a flowchart of an embodiment of a monitoring and management method for roaming charging station operator of the invention. The monitoring and management method for roaming charging station operator of the invention can be applied to a server.

First, in step S410, state data of at least one electric vehicle charging station corresponding to a charging station operator is first received via a network. It should be noted that, in some embodiments, the state data may include a usage status, an offline status, and/or a failure status corresponding to the at least one electric vehicle charging station. It should be noted that the aforementioned state data is only example, and the invention is not limited thereto. Thereafter, in step S420, a service quality index of the charging station operator or the at least one electric vehicle charging station is calculated according to the state data corresponding to the at least one electric vehicle charging station. It should be noted that, in some embodiments, the original state data can be normalized and standardized, so that the data can be transformed to obtain the service quality index represented by a numerical value. Then, in step S430, a user interface is provided to display the service quality index of the charging station operator or the at least one electric vehicle charging station.

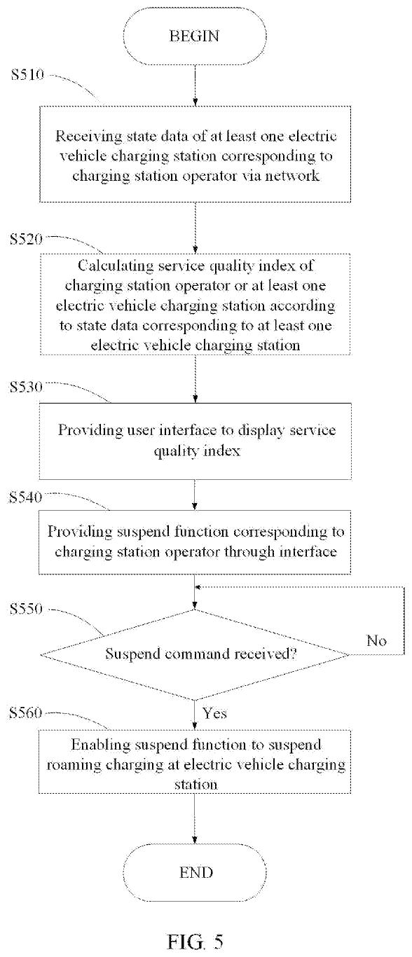

FIG. 5 is a flowchart of another embodiment of a monitoring and management method for roaming charging station operator of the invention. The monitoring and management method for roaming charging station operator of the invention can be applied to a server of a charging roaming management platform.

First, in step S510, state data of at least one electric vehicle charging station corresponding to a charging station operator is received via a network. Similarly, in some embodiments, the state data may include a usage status, an offline status, and/or a failure status corresponding to the at least one electric vehicle charging station. It should be noted that the aforementioned state data is only example, and the invention is not limited thereto. Thereafter, in step S520, a service quality index of the charging station operator or the at least one electric vehicle charging station is calculated according to the state data corresponding to the at least one electric vehicle charging station. Similarly, in some embodiments, the original state data can be normalized and standardized, so that the data can be transformed to obtain the service quality index represented by a numerical value. Then, in step S530, a user interface is provided to display the service quality index of the charging station operator or the at least one electric vehicle charging station. Next, in step S540, a suspend function corresponding to the charging station operator is provided through an interface. In step S550, it is determined whether a suspend command corresponding to the charging station operator is received through the network. When the suspend command corresponding to the charging station operator is not received (No in step S550), the determination in step S550 is repeated. When a suspend command corresponding to the charging station operator is received from an E-mobility service provider through the network (Yes in step S550), in step S560, in response to the suspend command, the suspend function is enabled to suspend roaming charging at the at least one electric vehicle charging station corresponding to the charging station operator.

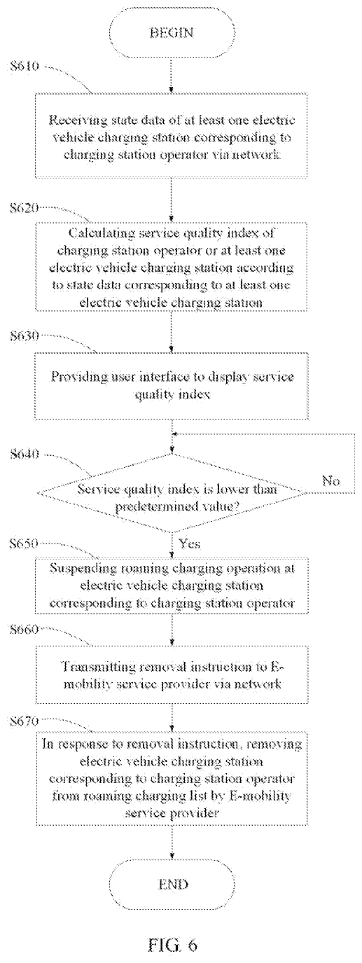

FIG. 6 is a flowchart of another embodiment of a monitoring and management method for roaming charging station operator of the invention. The monitoring and management method for roaming charging station operator of the invention can be applied to a server of a charging roaming management platform.

First, in step S610, state data of at least one electric vehicle charging station corresponding to a charging station operator is received via a network. Similarly, in some embodiments, the state data may include a usage status, an offline status, and/or a failure status corresponding to the at least one electric vehicle charging station. It should be noted that the aforementioned state data is only example, and the invention is not limited thereto. Thereafter, in step S620, a service quality index of the charging station operator or the at least one electric vehicle charging station is calculated according to the state data corresponding to the at least one electric vehicle charging station. Similarly, in some embodiments, the original state data can be normalized and standardized, so that the data can be transformed to obtain the service quality index represented by a numerical value. Then, in step S630, a user interface is provided to display the service quality index of the charging station operator or the at least one electric vehicle charging station. Next, in step S640, it is determined whether the service quality index is lower than a predetermined value. When the service quality index is not lower than the predetermined value (No in step S640), the determination in step S640 is repeated. When the service quality index is lower than the predetermined value (Yes in step S640), in step S650, the roaming charging operation at the at least one electric vehicle charging station corresponding to the charging station operator is suspended. Next, in step S660, a removal instruction is transmitted to at least one E-mobility service provider via the network. In step S670, in response to the removal instruction, the at least one electric vehicle charging station corresponding to the charging station operator is removed from a roaming charging list by the at least one E-mobility service provider. It is noted that the roaming charging list can record a plurality of candidate electric vehicle charging stations where members of the at least one E-mobility service provider can perform roaming charging. In other words, when one of the electric vehicle charging stations of the charging station operator is being removed from the roaming charging list, members will temporarily not be able to charge at this electric vehicle charging station of the charging station operator.

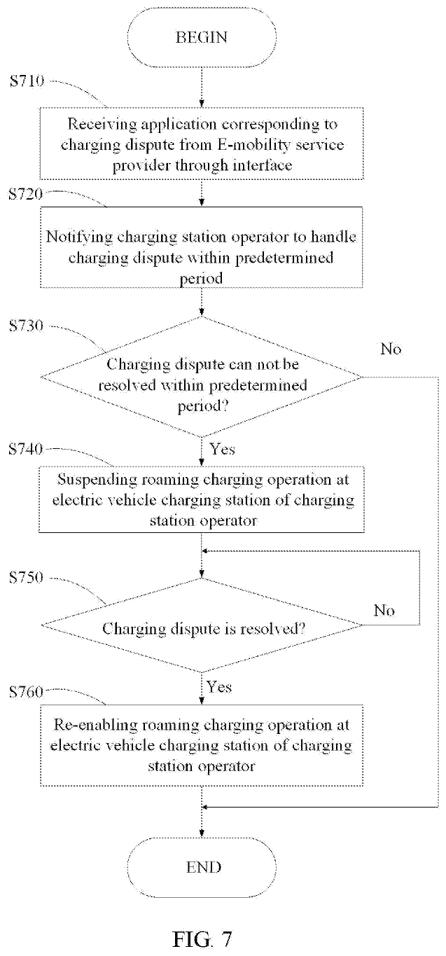

FIG. 7 is a flowchart of another embodiment of a monitoring and management method for roaming charging station operator of the invention. The monitoring and management method for roaming charging station operator of the invention can be applied to a server of a charging roaming management platform. In this embodiment, the charging roaming management platform can automatically perform related management operations based on charging disputes between charging station operators and E-mobility service providers.

First, in step S710, an application corresponding to the charging dispute is received from the at least one E-mobility service provider through an interface. In step S720, in response to the charging dispute application, the charging station operator is then notified to handle the charging dispute within the predetermined period through the interface. Next, in step S730, it is determined whether the charging dispute cannot be resolved within a predetermined period. When there is a charging dispute between the charging station operator and the electric mobility service provider, and the charging dispute has been resolved within a predetermined period (No in step S730), the flow ends. When there is a charging dispute between the charging station operator and the electric mobility service provider and the charging dispute cannot be resolved within the predetermined period (Yes in step S730), in step S740, the roaming charging operation at the at least one electric vehicle charging station of the charging station operator is suspended. Thereafter, in step S750, it is determined whether the charging dispute has been resolved. When the charging dispute is not resolved (No in step S750), the determination in step S750 is repeated. When the charging dispute has been resolved (Yes in step S750), in step S760, the roaming charging operation at the at least one electric vehicle charging station of the charging station operator is re-enabled to perform roaming charging again.

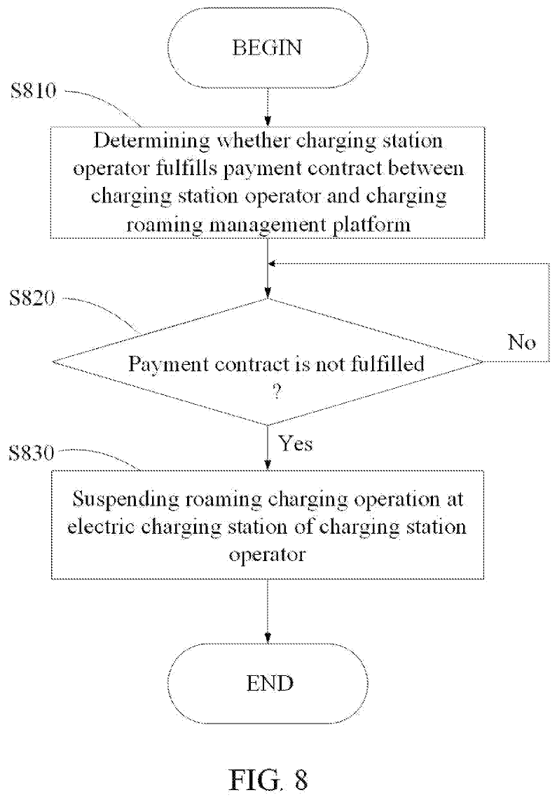

FIG. 8 is a flowchart of another embodiment of a monitoring and management method for roaming charging station operator of the invention. The monitoring and management method for roaming charging station operator of the invention can be applied to a server of a charging roaming management platform. In this embodiment, the charging roaming management platform can perform the related management operations according to the contract performance between the charging station operator and the charging roaming management platform.

First, in step S810, it is determined whether the charging station operator fulfills a payment contract between the charging station operator and the charging roaming management platform. When the payment contract is performed normally (No in step S820), the determination in step S820 is repeated. When the payment contract is not fulfilled (Yes in step S820), in step S830, the roaming charging operation at the at least one electric charging station of the charging station operator is suspended.

Therefore, through the monitoring and management systems and methods for roaming charging station operator of the invention, the roaming charging station operators can be monitored and managed based on the status of electric vehicle charging stations, charging disputes and/or contract performance between the charging station operator and the E-mobility service provider and the charging roaming management platform, thereby avoiding user complaints due to the unstable service quality of the charging station operator.

Monitoring and management methods for roaming charging station operator, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A monitoring and management method for a roaming charging station operator for use in a server, comprising:
receiving state data of at least one electric vehicle charging station corresponding to a charging station operator via a network;
calculating a service quality index of the charging station operator or the at least one electric vehicle charging station according to the state data corresponding to the at least one electric vehicle charging station; and
providing a user interface to display the service quality index of the charging station operator or the at least one electric vehicle charging station.

2. The method of claim 1, further comprising:
determining whether the service quality index is lower than a predetermined value; and
when the service quality index is lower than the predetermined value, suspending the roaming charging operation at the at least one electric vehicle charging station corresponding to the charging station operator.

3. The method of claim 2, further comprising:
transmitting a removal instruction to at least one E-mobility service provider via the network; and
in response to the removal instruction, removing the at least one electric vehicle charging station corresponding to the charging station operator from a roaming charging list by the at least one E-mobility service provider, wherein the roaming charging list records a plurality of candidate electric vehicle charging stations where at least one member of the at least one E-mobility service provider can perform roaming charging.

4. The method of claim 1, further comprising:
providing a suspend function corresponding to the charging station operator through an interface; and
receiving a suspend command from at least one E-mobility service provider through the network to enable the suspend function to suspend roaming charging at the at least one electric vehicle charging station corresponding to the charging station operator.

5. The method of claim 1, wherein the state data includes a usage status, an offline status, or a failure status corresponding to the at least one electric vehicle charging station.

6. The method of claim 1, further comprising:
determining whether there is a charging dispute between the charging station operator and at least one E-mobility service provider and the charging dispute cannot be resolved within a predetermined period; and
when there is a charging dispute between the charging station operator and the at least one E-mobility service provider and the charging dispute cannot be resolved within the predetermined period, suspending the roaming charging operation at the at least one electric vehicle charging station of the charging station operator.

7. The method of claim 6, further comprising re-enabling the roaming charging operation at the at least one electric vehicle charging station of the charging station operator when the charging dispute is resolved.

8. The method of claim 6, further comprising:
receiving an application corresponding to the charging dispute from the at least one E-mobility service provider through an interface; and
notifying the charging station operator to handle the charging dispute within the predetermined period through the interface.

9. The method of claim 1, wherein the server belongs to a charging roaming management platform, and the method further comprises:
determining whether the charging station operator fulfills a payment contract between the charging station operator and the charging roaming management platform; and
when the payment contract is not fulfilled, suspending the roaming charging operation at the at least one electric charging station of the charging station operator.

10. A monitoring and management system for a roaming charging station operator, comprising:
at least one electric vehicle charging station corresponding to a charging station operator for performing at least one charging operation on at least one electric vehicle; and
a server receiving state data of at least one electric vehicle charging station corresponding to a charging station operator via a network, calculating a service quality index of the charging station operator or the at least one electric vehicle charging station according to the state data corresponding to the at least one electric vehicle charging station, and providing a user interface to display the service quality index of the charging station operator or the at least one electric vehicle charging station.

11. The system of claim 10, wherein the server further determines whether the service quality index is lower than a predetermined value, and suspends the roaming charging operation at the at least one electric vehicle charging station corresponding to the charging station operator when the service quality index is lower than the predetermined value.

12. The system of claim 11, wherein the server further transmits a removal instruction to at least one E-mobility service provider via the network, and in response to the removal instruction, the server removes the at least one electric vehicle charging station corresponding to the charging station operator from a roaming charging list by the at least one E-mobility service provider, wherein the roaming charging list records a plurality of candidate electric vehicle charging stations where at least one member of the at least one E-mobility service provider can perform roaming charging.

13. The system of claim 10, wherein the server further provides a suspend function corresponding to the charging station operator through an interface, and receives a suspend command from at least one E-mobility service provider through the network to enable the suspend function to suspend roaming charging at the at least one electric vehicle charging station corresponding to the charging station operator.

14. The system of claim 10, wherein the state data includes a usage status, an offline status, or a failure status corresponding to the at least one electric vehicle charging station.

15. The system of claim 10, wherein the server further determines whether there is a charging dispute between the charging station operator and at least one E-mobility service provider, and the charging dispute cannot be resolved within a predetermined period, and when there is a charging dispute between the charging station operator and the at least one E-mobility service provider and the charging dispute cannot be resolved within the predetermined period, the server further suspends the roaming charging operation at the at least one electric vehicle charging station of the charging station operator.

16. The system of claim 15, wherein the server further re-enables the roaming charging operation at the at least one electric vehicle charging station of the charging station operator when the charging dispute is resolved.

17. The system of claim 15, wherein the server further receives an application corresponding to the charging dispute from the at least one E-mobility service provider through an interface and notifies the charging station operator to handle the charging dispute within the predetermined period through the interface.

18. The system of claim 15, wherein the server belongs to a charging roaming management platform, and the server further determines whether the charging station operator fulfills a payment contract between the charging station operator and the charging roaming management platform, and when the payment contract is not fulfilled, the server suspends the roaming charging operation at the at least one electric charging station of the charging station operator.

19. A machine-readable storage medium comprising a computer program, which, when executed, causes a device to perform a monitoring and management method for a roaming charging station operator, wherein the method comprises:
receiving state data of at least one electric vehicle charging station corresponding to a charging station operator via a network;
calculating a service quality index of the charging station operator or the at least one electric vehicle charging station according to the state data corresponding to the at least one electric vehicle charging station; and
providing a user interface to display the service quality index of the charging station operator or the at least one electric vehicle charging station.
